(19) United States
(12) Patent Application Publication
(10) Pub. No.: US 2026/0146498 A1
(43) Pub. Date: May 28, 2026

(54) SPRING MOTOR FOR TORQUE TRANSFORMER COIL SPRING AND IMPLEMENTATION THEREOF

(71) Applicants: Hsien-Te HUANG, Taipei City (TW); Yu-Wei HUANG, Taipei City (TW)

(72) Inventors: Hsien-Te HUANG, Taipei City (TW); Yu-Wei HUANG, Taipei City (TW)

(21) Appl. No.: 19/025,039

(22) Filed: Jan. 16, 2025

(30) Foreign Application Priority Data
Nov. 28, 2024 (TW) 113213012

(51) Int. Cl. E06B 9/322

(52) U.S. Cl. CPC E06B 9/322; E06B 2009/3222

(57) ABSTRACT

A spring motor for torque transformer coil spring and implementation thereof, which consists of a curtain assembly able to effect horizontal winding-unwinding of curtain blinds, configured with an operational spring motor and a torque transformer coil spring provided with elastic force feedback to take-up the curtain blinds. A belt section extends from the head end of a first belt length interval of the belt where the initial rising elastic reaction force occurs, and uses deformation stresses in the body section during the winding operation of the curtain blinds to enable initial letting down or final taking up thereof, thereby achieving extending distribution of deformation, which prevents the deformation stresses from being highly concentrated at a single point, and thus avoiding a critical elastic surge from occurring, causing a sudden change in the shape of the belt body resulting in metal fatigue and an explosive sound.

### BACKGROUND OF THE INVENTION

### (a) Field of the Invention

The present invention relates to a spring motor for torque transformer coil spring and implementation thereof, consisting of a curtain assembly able to effect horizontal winding-unwinding of curtain blinds, which is configured with an operational spring motor and a torque transformer coil spring provided with elastic reaction force to raise the curtain blinds. During the initial winding-unwinding process of the curtain blinds, the curtain assemble system effectively absorbs the sudden increase in elastic deformation of the torque transformer coil spring, thereby avoiding metal fatigue and an explosive sound from occurring.

### (b) Description of the Prior Art

Regarding a curtain assembly 10 able to effect horizontal winding-unwinding of curtain blinds 15 (as shown in FIG. 1), in a manually operated system, in order to solve the problem of fixing the height position of the horizontally lowered curtain blinds 15, and provide a design able to automatically raise the curtain blinds 15, such as disclosed in patent applications Taiwan Patent No. M533473 and U.S. Pat. No. 10,174,547 B2 submitted by the applicant of the present invention to the Taiwan and the United States Patent Offices, respectively, an elastic feedback capability generated by a torque transformer coil spring is provided that can adapt to the operating mode of the system. The hands are used to pull down and lower the curtain blinds 15, and when the hands are released, the torque transformer coil spring provides a varying counter-torque feedback, which balances the curtain blinds drawn and fixed at any vertical halfway position. And when raising the curtain blinds 15, transformation of the torque (stress) in a torque transformer coil spring 30 is used to enable obtaining a stable upward pulling speed that raises the curtain blinds 15. Regarding the elastic reaction curve of the torque transformer coil spring 30, as shown in the FIG. 1, the left side of the diagram shows a larger elastic reaction force that comes from a heavy force side 31 of the torque transformer coil spring 30 with a larger torque, and the right side shows a weaker elastic reaction force that comes from a weak force side 32 where the torque gradually weakens.

As a further explanation, the above-described torques are defined by the torque transformer coil spring 30 being a wound coiled body, and reversing the torque transformer coil spring 30 causes the reversed belt body to store the elastic reaction force generated due to deformation. The feedback operation drives a torque force that is able to rotate an object. The phrase “torque transformer” is to be understood as “converter” of torques, and “rising reaction force” as used below indicates a rise in elastic reaction force. In addition, the torque transformation curve shown in FIG. 1 corresponds to belt sections within the longitudinal body length of a spring belt wound onto the torque transformer coil spring 30, and is formed by connecting the torque values produced in each section.

Regarding elastic force feedback, the torques applied by the curtain assembly 10 to assist in upwardly pulling and raising the horizontal curtain blinds 15, as shown in FIG. 1, are produced by the torque transformer coil spring 30 in accordance with the elastic forces from the front and back of the length of the belt body that is mainly subdivided into the heavy force side 31 and the weak force side 32, whereby feedback torques are produced to correspondingly fix the curtain blinds 15 at a height between completely raising corresponding slats 150 and stacking thereof to form a slat stack W to completely lowering the curtain blinds 15. And pushing the curtain blinds 15 up by the hands to cancel static friction force is also regarded as a pull back feedback force that upwardly raises the curtain blinds 15.

Applying the above description to a spring motor 2 of the curtain assembly 10 enables the stored energy feedback to raise the curtain blinds 15. And such a system requires torque segmentation, for example, a lower beam 14 of the curtain blinds 15 positioned at a first height H1 and lowered to different height positions, such as a second height H2, a third height H3, and a fourth height H4, each require a different counterbalance to allocate the feedback force requirements of the lower beam 14. For example, raising the lower beam 14 to the position of the first height H1 requires the spring motor 2 to bear maximum feedback torque, because at the position of the first height H1 the spring motor 2 must bear the weight of the slats stack W formed by the stacking of all the slats 150. Hence, when the curtain blinds 15 are completely raised, the feedback torque of the stack load borne by the spring motor 2 is maximum, to prevent the lower beam 14 or the curtain blinds 15 from sliding down. Taking the different height sections as examples, the torque required at the position of the first height H1 is a first torque T1; and the torque required at the position of the fourth height H4 is a fourth torque T4, which is the lowest torque. The torque required in order to maintain a fixed position of the lower beam 14 at the position of the third height H3 to prevent the horizontal positioned lower beam 14 from sliding down is a third torque T3 responsible for serving as a counterbalance torque, which enables maintaining the lower beam 14 at the third height H3.

In the above-described lowering of the lower beam 14 to different height positions, the reason why the spring motor 2 bears different torques is because the upper ends of ladder cords 16 that enable varying the front and rear shading angle of the slats 150 are fixed to an upper beam 17, which is combined with the spring motor 2, thus, when lowering the body section of the slats 150 that are each connected at equidistant spacing to the lower beam 14, at the moment that the lower beam 14 is completely lowered to the lowermost position, the overall mass of all the slats 150 and the lower beam 14 is a load completely suspended by the ladder cords 16, at which time pull cords 12 can be regarded as bearing zero load.

During the process of raising the curtain blinds 15, each of the slats 150 is stacked layer by layer on the upper surface of the lower beam 14, and such stacking produces an equal increase in weight, with the weight formed accordingly requiring the pull cords 12 to distribute unequal values of pulling forces (torques) to fix the lower beam 14 at different height positions. Hence, because the fixing forces required to lower the lower beam 14 to different heights, varying torques are correspondingly fed back to the spring motor 2, forming a torque curve T0 shown in FIG. 1.

The above-described feedback forces determining the torques, in conjunction with the different gravity effects occurring at the different height positions when lowering/raising the curtain blinds 15, are all counterbalancing feedback torques with different values, enabling fixing the lower beam 14 at any height position. The system performs an equalizing counteraction to balance the feedback torques and the accumulated weight of the slats 150, enabling fixing the lower beam 14 leading the lowering/raising of the slats 150 at any height position, which is the same as fixing the height of the lower beam of the curtain blinds 15.

Regarding the operation of raising the curtain blinds 15, when a user's hands are used to push against the lower beam 14 from the bottom upwards to cancel the static friction of the system, the energy feedback released by the spring motor 2 is used to exert a motive force, which in conjunction with the inertial force of the ascending curtain blinds 15 achieves an all-way feedback retrieval effect of the curtain blinds 15.

The graph illustrated in FIG. 1 shows that a larger torque value must be borne from the start of the second torque T2 to the third torque T3, and is defined here as the heavy force side 31. The values of the third torque T3 to the fourth torque T4 are decreasing, and is defined here as the weak force side 32. The above-described order of torques depends on the belt length of the torque transformer coil spring 30, and are examples of the length positions where different torques occur.

Regarding the torque curve T0 produced as described above, the torque is zero at the starting point end of the belt forming the torque transformer coil spring 30, and the torque distributes in the direction of a large angle of elevation, and is proportionally larger when reaching the position of the first belt length interval L1, rapidly producing the first torque T1. At the position of the second belt length interval L2 a short distance from the first belt length interval L1, there is an easing in the rise of energy feedback produced by the second torque T2. The torque curve from the positions of the second belt length interval L2 to the third belt length interval L3 maintains a horizontal line. The torque distribution after the third belt length interval L3 gradually decreases to the position of the fourth belt length interval L4, and the torque distribution gradually decreases to the fourth torque T4.

Regarding the head end of the above-described torque transformer coil spring 30, the torque curve T0 starts at zero from the head end of the body length of the spring belt, then the torque rises at a proportionally large angle of elevation to the position of the first belt length interval L1. During the initial raising and lowering process of the curtain blinds 15, a clear deformation in shape occurs in the belt section of the first belt length interval L1 itself, which connectively causes the occurrence of a concentration of elastic stress at a certain position, with an elastic surge occurring when a critical point is reached.

In an embodiment of the spring belt 3 (referring to FIG. 2), a fastening end 300 is provided at the head end of the heavy force side 31 that hooks onto the circumferential surface of a reserve wheel 24. The initial action of pulling down the curtain blinds 15, as shown in FIG. 1, connectively drives the first belt length interval L1 including the connected rear sections of the spring belt 3, which successively wind round following the curvature of the outer circumference of the reserve wheel 24, sequentially generating strong and weak elastic energy feedback. Referring to FIG. 1, regarding the torque in the head end section of the first belt length interval L1 on the heavy force side 31, the action of pulling down the curtain blinds 15 leads and winds round the head end section onto the reserve wheel 24, whereby energy feedback is stored.

Referring to FIG. 3, the following first introduces the production of the torque transformer coil spring 30, which is constructed using a long strip of metal belt in a wound round format, similar to the format used for stationery adhesive tape, and the coaxial winding is obtained by quenching the ring-shaped coiled structure. Within the length of the belt, each section is incurved with a different arched curvature cross section, (an arched curvature structuring concept is shown in FIG. 5), wherein the different arched curvatures respectively store a different elastic reaction force that respond with different torques. Regarding the operation of the different elastic reactions, when the belt body is on a restore feedback wheel 23 in the opposing space position to the reserve wheel 24, the space is used to enable the belt body of the spring belt 3 to be free from restraint, and can freely elastically restore its shape, whereupon the elastic recovery ability enables releasing different amounts of reaction forces, which derive different elastic torques through rotating wheels.

The torque transformer coil spring 30 shown in FIG. 3 is configured by first fastening the head end of the fastening end 300 onto the outer circumference of the reserve wheel 24, and as the curtain blinds 15 are raised, the remaining belt body of the spring belt 3 successively restores its original structural form, returning and rewinding back onto the restore feedback wheel 23. This distribution state (referring in conjunction with the drawing shown FIG. 1 for the following description) is realized by pulling the curtain blinds 15 upward to the top position, whereupon the torque transformer coil spring 30 produces maximum torque sufficient to hold and fix the curtain blinds 15 stacked with maximum accumulated weight at the top position.

In the state where the curtain blinds 15 are completely raised, the cords of two side pull cords 12 are respectively completely reeled in by a first reel drum 21 and a second reel drum 22. When the time comes to lower the curtain blinds 15 again, the user's hands are used to pull down the lower beam 14. The pulling forces during the process of puling down on the two pull cords 12 produce torque effects along the two pull cords 12 affecting the first reel drum 21 and the second reel drum 22, causing the first reel drum 21 and the second reel drum 22 to rotate. The first reel drum 21 and the second reel drum 22 respectively mesh with gear wheels 210, 220, and the gear wheels 210, 220 coaxially configured with gear wheels 230 and 240 form an intermeshing combination, which enable engaging with the restore feedback wheel 23 and the reserve wheel 24. The reserve wheel 24 then winds up the first belt length interval L1 of the spring belt 3 from the head end thereof, after which the second, third, and fourth belt length intervals L2, L3, and L4 of the spring belt 3 are successively wound up in reverse, enabling the spring belt 3 to gradually generate continuous high and low elastic energy storage.

In designs of the prior art, problems lie in the elastic curvature of the first belt length interval L1 of the torque transformer coil spring 30 that produces a torque that rises at a large angle of elevation. Moreover, the large cross-sectional curvature of the structure of the first belt length interval L1 of the spring belt 3 and the addition of being wound in the opposite direction to the original winding direction of the torque transformer coil spring 30; such reverse winding of the spring belt 3 within a very short length of the belt body thereof causes rapid transformation that forms a difference in structural configuration with large curvature. Hence, the instant the outer circumferential surface of the reserve wheel 24 begins to wind round the head end of the first belt length interval L1, the first belt length interval L1 undergoes a rapid and large deformation. And the deformation stress in the deformation section causes regular or irregular concentration of point positions, affecting structural integrity of the metal. After an accumulation of time, when a critical time is reached, a deformation shock wave surges through the structure, causing an explosive sound and, most importantly, accelerated fatigue of the metal structure of the belt body.

Referring to FIG. 4 (in conjunction with FIG. 3), which shows operational application on an incurved wheel surface 241 of the reserve wheel 24, such as disclosed in patent applications Taiwan Patent No. M516386 and U.S. Pat. No. 10,000,967 B2 submitted by the applicant of the present invention to the Taiwan and the United States Patent Offices, respectively, the main claims of which disclose that the incurved wheel surface 241 formed as an arched indentation on the outer circumference of the reserve wheel 24 enables arched combined windings thereon, whereby at the start of winding round the first belt length interval L1, the cross-section of the body section thereof is incurved with a large curvature, the mouth of which faces away from the curved surface of the incurved wheel surface 241, with the addition of the diameter between the upper and lower sides of the incurved wheel surface 241 being larger than the central incurved encircling belt, the section of the first belt length interval L1 of the spring belt 3 initially wound onto the reserve wheel 24 bears the change in curvature of the longitudinal body of the spring belt 3. And under the greater tensions at the upper and lower edges of the larger diameter incurved wheel surface 241, longitudinal pulling forces on the upper and lower side edges of the spring belt 3 are greater than at the longitudinal center of the body of the spring belt 3. Hence, the pulling forces further pull in different stresses to the center of the spring belt 3, which combine to produce cumulative stress thereat, thereby producing a more intense elastic stress surge.

### SUMMARY OF THE INVENTION

The main object of the present invention lies in implementation of a spring motor for a torque transformer coil spring, wherein the spring motor for the torque transformer coil spring and implementation thereof consists of a curtain assembly able to effect horizontal raising and lowering of horizontal slats of curtain blinds, wherein a body section integrally extends from the head end of a spring belt of the torque transformer coil spring configured to the spring motor, which enables avoiding concentration of deformation stress on a certain point resulting from the change in shape in a section of a first belt length interval at the head end of a heavy force side of the spring belt during the winding operation process, causing an explosive sound, and preventing metal fatigue from occurring.

Another objective of present invention lies in additionally providing a guide section indirectly between the body section and the first belt length interval, to enable a progressive deformation response of the first belt length interval.

A third objective of present invention lies in providing the outer circumferential surface of a reserve wheel of the spring motor with an incurved wheel surface having an arched incurved curvature, whereby after the body section leads the winding round the incurved wheel surface, the body section also enables subsequent coiled structuring or/and overlay winding of the guide section, to serve as a cushioning effect.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 is a torque curve-curtain assembly correspondence diagram of a torque transformer coil spring of the prior art.

FIG. 2 is a three-dimensional view of a spring belt combining with a reserve wheel of the prior art.

FIG. 3 is a structural top view of a spring motor of the prior art.

FIG. 4 is a side view of the reserve wheel provided with an incurved wheel surface of the prior art.

FIG. 5 is a torque distribution diagram of a spring belt according to the present invention.

FIG. 6 is a schematic diagram of the operational performance of a body section and a guide section according to the present invention.

FIG. 7 is a side view of the initial mutual relationship between winding of the spring belt and the incurved wheel surface according to the present invention.

FIG. 8 is a first side view of the initial mutual relationship between winding of the spring belt and the incurved wheel surface according to the present invention.

FIG. 9 is a second side view of the initial mutual relationship between winding of the spring belt and the incurved wheel surface according to the present invention.

FIG. 10 is a third side view of the initial mutual relationship between winding of the spring belt and the incurved wheel surface according to the present invention.

### DETAILED DESCRIPTION OF THE PREFERRED EMBODIMENTS

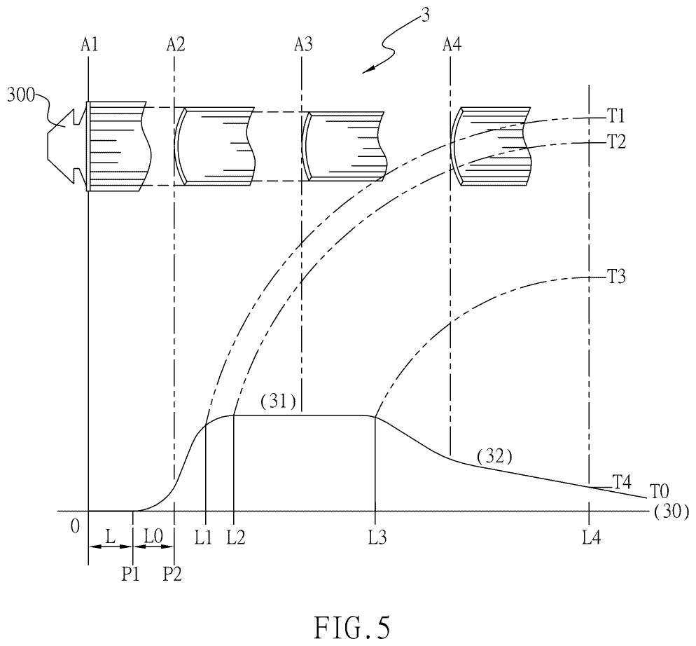

Regarding the above-described past implementations of a curtain assembly, the technological means adopted in the present invention to resolve the deformation surge in a first belt length interval of a torque transformer coil spring or the greater cumulative surge effect when applied on a reserve wheel with an incurved wheel surface involves additionally providing the front end of a first belt length interval L1 of a torque transformer coil spring 30 with a body section L (referring first to FIG. 5) that gradually changes into a section of the first belt length interval L1, which enables cushioning a deformation stress when being reversely wound round, thereby maintaining stability of the system components, and preventing metal structure fatigue and a deformation explosive sound from occurring in this section.

As shown in FIG. 5, a spring belt 3 made into the torque transformer coil spring 30 is positionally aligned with the horizontal coordinate line of a torque distribution diagram, and shows the longitudinal length of the spring belt 3 and a torque curve T0 showing the distribution of different torque values in each section thereof.

During production of the spring belt 3, different concave curvatures in the cross sections of the belt body of the spring belt 3 are produced in advance by quenching after being wound round.

A second cross section A2, a third cross section A3, and a fourth cross section A4 of different sections in the front and rear of the longitudinal body of the spring belt 3 are respectively produced with different cross-section curvatures. And the cross sections with varying curvatures are used to distribute different torques. FIG. 5 shows a torque curve T0 of a front and back heavy force side 31 and a weak force side 32 of the spring belt 3.

In order to resolve the problem of elastic stress surge in past curtain assemblies, in the present invention, a body section L additionally extends from and is integrally connected to the head end of the first belt length interval L1. The cross section of the body section L is a flat first cross section A1, which has a torque force value of zero; however, this belt section is similarly elastic (this description overlooks the shape and structural stress from the winding direction of the body section L during manufacture thereof to form the torque transformer coil spring 30).

In order to ease the rapid rise in the torque force per unit length, a guide section L0 is indirectly provided between the body section L and the first belt length interval L1. The head end of the guide section L0 is positioned at the end of the body section L associated with a starting point P1, where torques begin to be produced through a progressive winding method. The torques progressively increase up to the position of a connecting point P2, where the second cross section A2 is formed that connects with the corresponding start of the first belt length interval L1, forming an easing effect in the rise in torque force. The first belt length interval L1 successively connects to a second belt length interval L2, and a third belt length interval L3 connects to a fourth belt length interval L4, wherein the first to fourth cross sections A1, A2, A3, and A4 of each interval are concavely formed with different curvatures according to the respective body section of the spring belt 3, forming different torque responses accordingly. The torque force distribution of the above-described spring belt 3 leaves out a description of the applied force of the section of a fastening end 300.

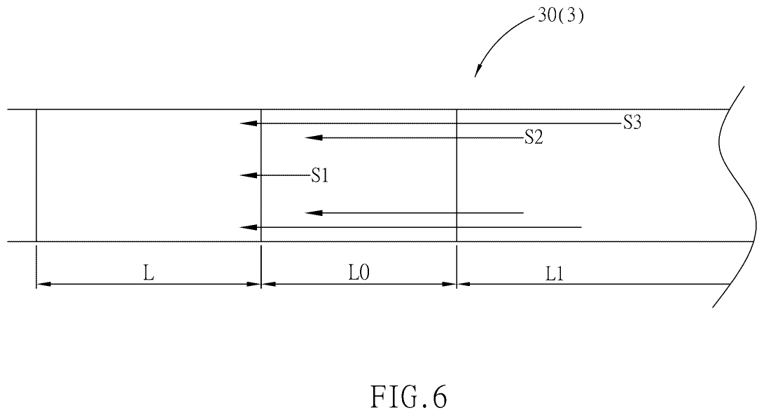

Referring to FIG. 6, which shows the spring belt 3 of the torque transformer coil spring 30, wherein the beginning of the first belt length interval L1 is connected to the guide section L0 and the body section L, which are used to assist in absorbing the huge deformation stress in the first belt length interval L1, wherein the body section L directly absorbs a deformation stress S1 in the guide section L0; the guide section L0 directly absorbs a deformation stress S2 in the first belt length interval L1; and the body section L assists in indirectly absorbing an overall deformation stress S3 that passes through the guide section L0. In such a structural configuration of the spring belt 3, the body section L bears the deformation stress of the adjoining guide section L0 and the first belt length interval L1, which, during the process of a strong deformation surge in the first belt length interval L1, enables significantly avoiding structural deformation.

In an applied system, the additional body section L and the guide section L0 of the present invention assists the initial first belt length interval L1 of the spring belt 3 to achieve an easing effect by absorbing deformation stress from when initially letting down curtain blinds 15 or from the initial instance of an elastic feedback force when raising the curtain blinds 15.

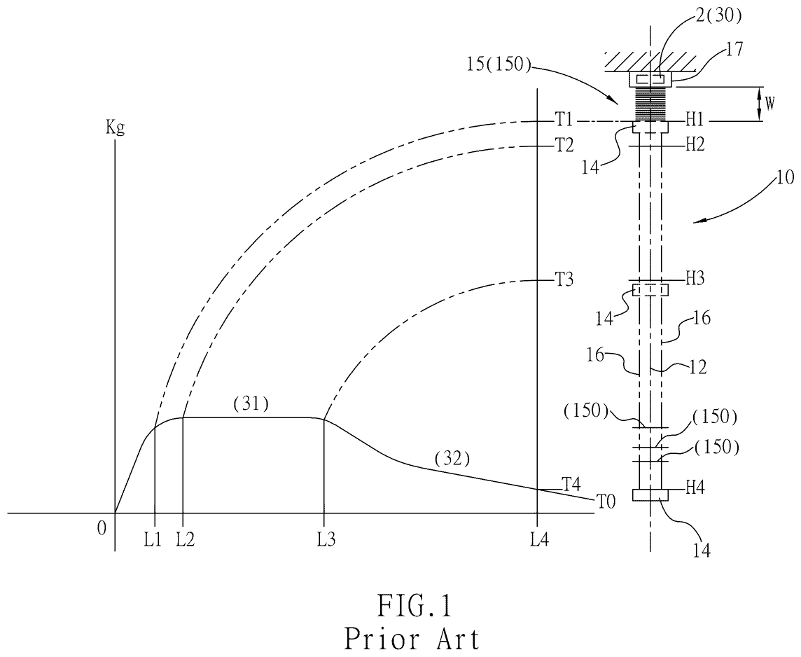

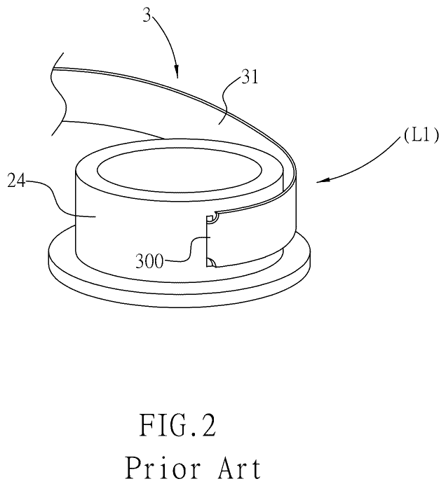

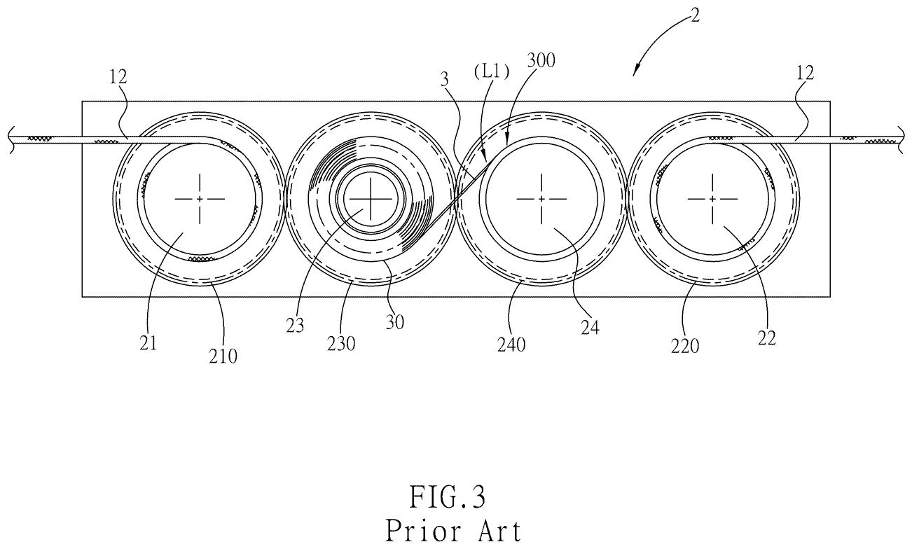

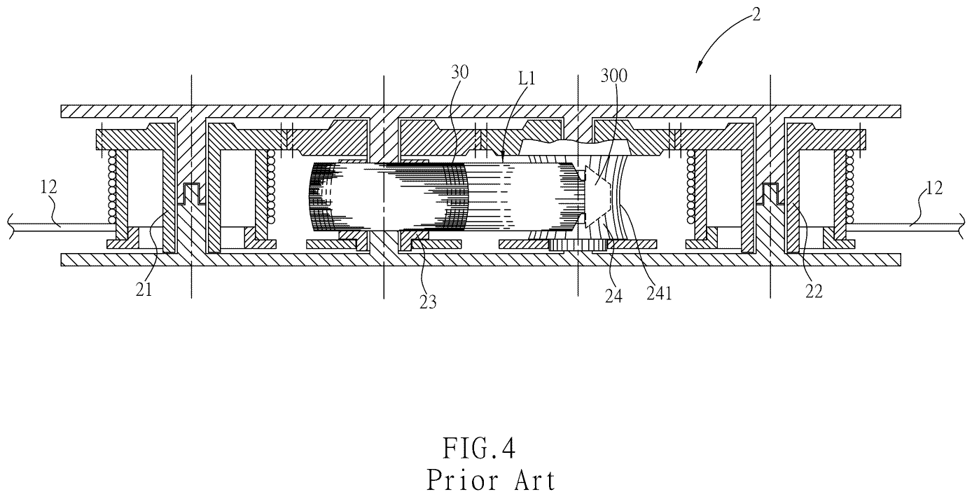

In an additional explanation, using a downward pulling force to manually lower the curtain blinds 15 by means of pull cords 12 (referring in conjunction with FIG. 1 and FIG. 3) actuates a first reel drum 21 and a second reel drum 22, which then mesh with a reserve wheel 24 that begins winding the heavy force side 31 on the first belt length interval L1 of the torque transformer coil spring 30.

The length of the body section L must be sufficient for at least more than one lead winding on the outer circumference of the reserve wheel 24, which, after winding, can also serve as a preparatory cushioning effect.

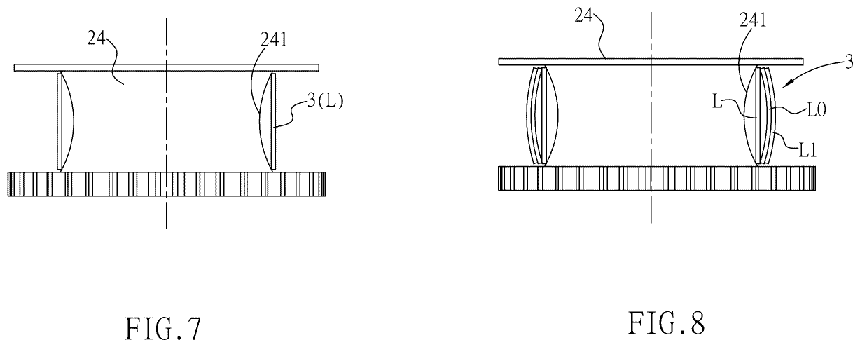

Referring to FIGS. 7 to 10, which show the cushioning effect, and referring first to FIG. 7, the lead end of the body section L of the spring belt 3 is first wound round the outer circumference of the reserve wheel 24 at least once, in particular, in an application wherein the reserve wheel 24 operates in coordination with an incurved wheel surface 241 thereof, the upper and lower sides of the belt of the body section L are pre-wound in advance on the upper and lower radial rims of the surface of the incurved wheel surface 241, in preparation for subsequent overlaid windings, to bring about an easing effect.

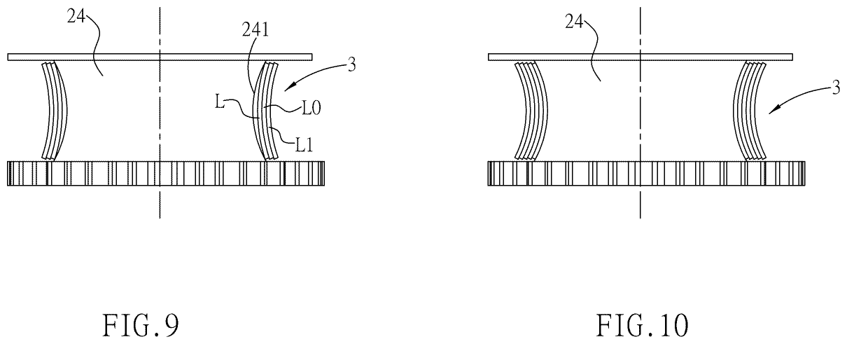

Referring to FIGS. 8 to 10, after the body section L of the spring belt 3 has been wound round the outer circumference of the reserve wheel 24 more than once, subsequent winding enables overlaying of the guide section L0 with a further successive overlay winding of the first belt length interval L1. The arched curvature of the first belt length interval L1 is directed toward the incurved wheel surface 241, and the successive outward laminated winding structure presses and incurves the cross-section of the first belt length interval L1 (see the schematic diagram shown in FIG. 9). This reverse deformation of the first belt length interval L1 has the same arched curvature of the incurved wheel surface 241, storing a strong elastic reaction force, as well as reserving energy feedback for raising the curtain blinds 15. During the deformation process shown in FIGS. 8 to 9, the belt body of the body section L has a cushioning effect, providing the arched deformation response of the first belt length interval L1 with a cushioning elastic buffer. In test results of the present invention, the body section L must be completely wound round the reserve wheel 24 at least once.

From the schematic states shown in FIGS. 9 and 10, it can be seen that the winding state of subsequent layering of the spring belt 3 on the reserve wheel 24 is mainly brought about during the process of the initial winding of the body section L being subjected to subsequent accumulated windings of curved cross-section belt body sections of the spring belt 3, whereby an elastic displacement response is generated between the flat cross-section of the body section L and the indented space of the incurved wheel surface 241, which is followed by a force applied on the center point of the arched curvature structure of subsequent belt body sections, which presses and causes the corresponding center point of the belt body of the body section L to curve downward toward the center of the indented space of the incurved wheel surface 241. The elasticity of the body section L itself and the acquired elasticity from being curved into the incurved space provide the cushioning effect during the process of subsequent windings of belt body sections.

According to the aforementioned structural configuration, the present invention prevents a curtain blinds spring motor 2 from producing an explosive sound during operation. Furthermore, using the body section L assisted by the guide section L0 enables absorbing the deformation stress in the first belt length interval L1, thereby preventing metal fatigue caused by stress concentration, and thus achieving an easing and safety effect.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A torque transformer coil spring, which is a torque transformer coil spring able to effect easing the rising and lowering of elastic feedback forces, wherein the torque transformer coil spring is installed inside a spring motor used by a curtain assembly to effect horizontal raising as well as lowering of curtain blinds, comprising:
a coiled structure consisting of a spring belt wound onto the torque transformer coil spring, torques are distributed along a longitudinal length of the spring belt according to a heavy force side and a weak force side thereof, a belt head of the heavy force side is a first belt length interval, a guide section integrally extends from the head end of the first belt length interval, and the guide section further extends and combines with a body section.

2. The torque transformer coil spring according to claim 1, wherein the length of the body section is sufficient to wind round more than one circumferential length of an operational reserve wheel.

3. The torque transformer coil spring according to claim 1, wherein a fastening end connects to the head end of the body section.

4. A spring motor, which enables horizontal raising as well as lowering of curtain blinds, and is used to produce an elastic feedback force to raise curtain blinds of a curtain assembly, comprising:
a restore feedback wheel and a reserve wheel that mutually mesh;
the restore feedback wheel and the reserve wheel respectively mesh with a first reel drum and a second reel drum;
a torque transformer coil spring formed by winding a spring belt is able to transform torque feedback, an elastic reaction force produced on an inner side of the wound spring belt is a weak force side, and an elastic reaction force produced on an outer side of the wound spring belt is a heavy force side;
the head end of the heavy force side at one end of the spring belt is a first belt length interval, a guide section integrally extends from the head end of the first belt length interval, and the guide section further extends and combines with a body section, an outer end of the body section is further provided with a fastening end, which fastens to an outer circumference of the reserve wheel.

5. The spring motor according to claim 4, wherein the wheel surface of the reserve wheel is radial incurved with an arc curved incurved wheel surface.

6. The spring motor according to claim 4, wherein the length of the body section is sufficient to wind round more than one circumferential length of the reserve wheel.
